(19) United States
(12) Patent Application Publication
(10) Pub. No.: US 2003/0215689 A1
(43) Pub. Date: Nov. 20, 2003

(54) Solid oxide fuel cell with a metal foam seal

(76) Inventor: Kevin R. Keegan, Hilton, NY (US)

Correspondence Address: Vincent A. Cichosz, Delphi Technologies, Inc, M/C 480-410-202, P.O. Box 5052, Troy, MI, 48007-5052, US

(21) Appl. No.: 10/147,406

(22) Filed: May 16, 2002

(51) Int. Cl. H01M 8/02; H01M 2/08

(52) U.S. Cl. 429/35; 429/30; 29/623.2

(57) ABSTRACT

Disclosed herein are a solid oxide fuel cell and a method for making the same. In one embodiment, the solid oxide fuel cell comprises: A solid oxide fuel cell, comprising: an electrolyte disposed between and in ionic communication with a first electrode and a second electrode, forming an electrochemical cell; a flow plate disposed adjacent to and in electrical communication with at least a portion of the electrochemical cell; and a seal member sealably engaging the flow plate, wherein the seal member comprises a foam selected from the group consisting of a metal, a metal alloy, and combinations comprising at least one of the foregoing foams.

In one embodiment, the method of manufacturing the solid oxide fuel cell, comprises: disposing a first electrode and a second electrode on opposite sides of a solid electrolyte; disposing a flow plate adjacent to and in electrical communication with at least a portion of the electrochemical cell; and disposing the seal member in sealable engagement with the flow plate.

### BACKGROUND

Alternative transportation fuels have been represented as enablers to reduce toxic emissions in comparison to those generated by conventional fuels. At the same time, tighter emission standards and significant innovation in catalyst formulations and engine controls have led to dramatic improvements in the low emission performance and robustness of gasoline and diesel engine systems. This has certainly reduced the environmental differential between optimized conventional and alternative fuel vehicle systems. However, many technical challenges remain to make the conventionally-fueled internal combustion engine a nearly zero emission system having the efficiency to make the vehicle commercially viable.

Alternative fuels cover a wide spectrum of potential environmental benefits, ranging from incremental toxic and carbon dioxide (CO₂) emission improvements (reformulated gasoline, alcohols, LPG, etc.) to significant toxic and CO₂ emission improvements (natural gas, DME, etc.). Hydrogen is clearly the ultimate environmental fuel, with potential as a nearly emission free internal combustion engine fuel (including CO₂ if it comes from a non-fossil source). Unfortunately, the market-based economics of alternative fuels, or new power train systems, are uncertain in the short to mid-term.

The automotive industry has made very significant progress in reducing automotive emissions in both the mandated test procedures and the “real world”. This has resulted in some added cost and complexity of engine management systems, yet those costs are offset by other advantages of computer controls: increased power density, fuel efficiency, drivability, reliability and real-time diagnostics.

Future initiatives to require zero emission vehicles appear to be taking us into a new regulatory paradigm where asymptotically smaller environmental benefits come at a very large incremental cost. Yet, even an “ultra low emission” certified vehicle can emit high emissions in limited extreme ambient and operating conditions or with failed or degraded components.

One approach to addressing the issue of emissions is the employment of fuel cells, particularly solid oxide fuel cells (“SOFC”), in an automobile. A fuel cell is an energy conversion device that generates electricity and heat by electrochemically combining a gaseous fuel, such as hydrogen, carbon monoxide, or a hydrocarbon, and an oxidant, such as air or oxygen, across an ion-conducting electrolyte. The fuel cell converts chemical energy into electrical energy. SOFCs are constructed entirely of solid-state materials, utilizing an ion conductive oxide ceramic as the electrolyte. A conventional electrochemical cell in a SOFC is comprised of an anode and a cathode with an electrolyte disposed there between. The oxidant passes over the oxygen electrode (cathode) while the fuel passes over the fuel electrode (anode), generating electricity, water, and heat.

In a typical SOFC, a fuel flows to the anode where it is oxidized by oxygen ions from the electrolyte, producing electrons that are released to the external circuit, and mostly water and carbon dioxide are removed in the fuel flow stream. At the cathode, the oxidant accepts electrons from the external circuit to form oxygen ions. The oxygen ions migrate across the electrolyte to the anode. The flow of electrons through the external circuit provides for consumable or storable electricity. However, each individual electrochemical cell generates a relatively small voltage. Higher voltages are attained by electrically connecting a plurality of electrochemical cells in series to form a stack.

The SOFC cell stack also includes conduits or manifolds to allow passage of the fuel and oxidant into and byproducts, as well as excess fuel and oxidant, out of the stack. Generally, oxidant is fed to the structure from a manifold located on one side of the stack, while fuel is provided from a manifold located on an adjacent side of the stack. The fuel and oxidant are generally pumped through the manifolds and introduced to a flow field disposed adjacent to the appropriate electrode. The flow fields that direct the fuel and oxidant to the respective electrodes typically create oxidant and fuel flows across the electrodes that are perpendicular to one another.

Suitable seals are disposed around the edges of the various cell stack components to inhibit cross-over of fuel and/or oxidant. For example, seals are disposed between the electrodes and adjacent flow fields, around manifolds, between flow fields and cell separators, and elsewhere. One factor in establishing SOFC reliability is the integrity of these seals.

Leaks in the manifold seals, electrochemical seals, or other defects can lead to the SOFC failure. When oxygen crosses over to the anode, forming an oxidizing environment, anode oxidation can occur, creating a chemical and volume change that results in mechanical failure of the SOFC cell. The long term successful operation of a fuel cell depends primarily on maintaining structural and chemical stability of fuel cell components during steady state conditions, as well as transient operating conditions such as cold startups and emergency shut downs. The support systems are required to store and control the fuel, compress and control the oxidant and provide thermal energy management. A SOFC can be used in conjunction with a reformer that converts a fuel to hydrogen and carbon monoxide (the reformats) usable by the fuel cell. Three types of reformer technologies are typically employed (steam reformers, dry reformers, and partial oxidation reformers) to convert hydrocarbon fuel (methane, propane, natural gas, gasoline, etc) to hydrogen using water, carbon dioxide, and oxygen, respectfully, with byproducts including carbon dioxide and carbon monoxide, accordingly. These reformers operate at high temperatures (e.g., about 800° C. or greater).

Sealing of the interface between the gas manifolds and the cell of a SOFC is an area in need of improvement. The very high temperatures, often ranging from 800° C. to over 1000° C. create large differences in strain due to thermal expansion over the large temperature differentials, and fuel pressures the seals maintain against.

### SUMMARY

Disclosed herein are a solid oxide fuel cell and a method for making the same. In one embodiment, the solid oxide fuel cell comprises: A solid oxide fuel cell, comprising: an electrolyte disposed between and in ionic communication with a first electrode and a second electrode, forming an electrochemical cell; a flow plate disposed adjacent to and in electrical communication with at least a portion of the electrochemical cell; and a seal member sealably engaging the flow plate, wherein the seal member comprises a foam selected from the group consisting of a metal, a metal alloy, and combinations comprising at least one of the foregoing foams.

In one embodiment, the method of manufacturing the solid oxide fuel cell, comprises: disposing a first electrode and a second electrode on opposite sides of a solid electrolyte; disposing a flow plate adjacent to and in electrical communication with at least a portion of the electrochemical cell; and disposing the seal member in sealable engagement with the flow plate.

The above described and other features are exemplified by the following figures and detailed description.

### BRIEF DESCRIPTION OF THE DRAWINGS

Referring now to the drawings wherein like elements are numbered alike in the several figures:

FIG. 1 is an expanded isometric view of an electrochemical cell of a SOFC;

FIG. 2 is a schematic of the operation of a SOFC;

FIG. 3 is a schematic view of an SOFC showing seal member;

FIG. 4 is an exploded view of FIG. 3, cutaway area A; and

FIG. 5 is an exploded partial view of an SOFC showing a plurality of seal members.

### DESCRIPTION OF THE PREFERRED EMBODIMENT

Different types of SOFC systems exist, including tubular or planar systems. These various systems operate with different cell configurations. Therefore, reference to a particular cell configuration and components for use within a particular cell configuration are intended to also represent similar components in other cell configurations where applicable.

Generally, the system may comprise at least one SOFC, an engine, at least one heat exchanger, and optionally, one or more compressors, an exhaust turbine, a catalytic converter, preheating device, plasmatron, electrical source (e.g., battery, capacitor, motor/generator, turbine, and the like, as well as combinations comprising at least one of the foregoing electrical sources), and connections, wiring, control valves, and a multiplicity of electrical loads, including, but not limited to, lights, resistive heaters, blowers, air conditioning compressors, starter motors, traction motors, computer systems, radio/stereo systems, and a multiplicity of sensors and actuators, and the like, as well as conventional components.

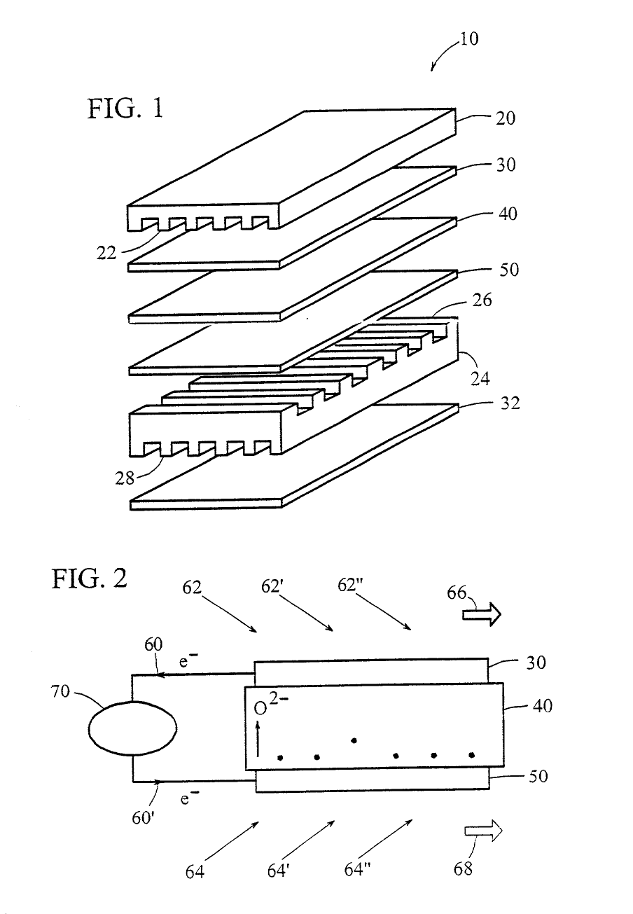

One configuration of a SOFC includes a stack of planar SOFCs. An electrochemical cell stack 10 is illustrated in FIG. 1. A fuel electrode or anode 30 and an oxygen electrode or cathode 50, are disposed on opposite sides of a solid electrolyte 40. An end cap 20 includes a surface 22 that is configured for disposal adjacent to the anode 30 for both electrical contact and also to provide fuel distribution. An interconnect 24 includes a first interconnect surface 26, and a second interconnect surface 28. First interconnect surface 26 is configured for disposal adjacent to cathode 50, to provide oxidant distribution and electrical contact. Second interconnect surface 28, is configured for disposal adjacent to an anode 32 of another SOFC. Anode 32 is disposed adjacent to interconnect 22 to illustrate the placement of and ability to stack several electrochemical cells in electrical connected to electrochemical cell 10. End cap 20 functions essentially the same way as does interconnect 24. For reasons of simplicity, end cap 20 and interconnect 24 are referred to hereinafter generically as flow plate 25, unless otherwise noted.

The electrolyte 40 of the electrochemical cell 10 can be an ion conductor, that is capable of transporting oxygen ions from the cathode 50 to the anode 30, and that is compatible with the environment in which the SOFC will be utilized (e.g., temperatures of about −40° C. up to about 1,000° C.). Generally, the electrolyte can include materials such as ceramics, and/or metals (e.g., alloys, oxides, gallates, and the like), including zirconium, yttrium, calcium, magnesium, aluminum, rare earths, and the like, as well as oxides, gallates, aluminates, combinations, and composites comprising at least one of the foregoing materials. Preferably the electrolyte is a rare earth oxide (such as yttria, gadolinia, neodymia, ytterbia, erbia, ceria, and the like, and mixtures comprising at least one of the foregoing oxides) doped with aliovalient oxide(s) (such as magnesia, calcia, strontia, and the like, and other 2+valence metal oxides).

The anode 30 and cathode 50, form phase boundaries with the electrolyte 40, and can be disposed adjacent to, or integral with the electrolyte 40. The anode 30 and cathode 50 are generally formed from a porous material that is capable of functioning as an electrical conductor, and that is capable of facilitating the appropriate reactions. The porosity of these materials should be sufficient to enable dual directional flow of gases (e.g., to admit the fuel or oxidant gases and permit exit of the byproduct gases), with a porosity of about 20% to about 40%, typically preferred.

The composition of the anode 30 and cathode 50 can comprise elements including calcium, zirconium, yttrium, nickel, manganese, strontium, lanthanum, titanium, iron, cobalt, and the like, as well as oxides, alloys and combinations comprising at least one of the foregoing elements such as, for example, perovskite (CaTiO₃). Preferably, the anode material is formed upon a ceramic skeleton, such as yttria-stabilized zirconia, which also provides for thermal compatibility.

Either or both the anode 30 and the cathode 50 can be formed on the electrolyte 40 by a variety of techniques including sputtering, chemical vapor deposition, screen printing, spraying, dipping, painting, and stenciling, among others. The electrodes are disposed typically up to about 1,000 micrometers in thickness, with a thickness of about 5 micrometers to about 50 micrometers preferred.

The electrochemical cell 10 can be electrically connected with other electrochemical cells by using, for example, interconnect 24. Depending upon the geometry of the SOFC, the fuel and the oxidant flow to the anode or cathode (as appropriate) via the passageways within flow plate 25. Flow plate 25 is generally formed of a material capable of withstanding the pressures and temperatures of the SOFC, and capable of conducting electricity. For example, suitable flow plate(s) can be formed from non-integral conductive wool, fibers (chopped, woven, non-woven, long, and the like), felt, mat, and the like, from materials capable of withstanding the operational temperatures of the cell, (e.g., temperatures of about −40° C. to about 1,000° C.). Flow plates are preferably formed from an electrically conductive material, which is compatible with the oxidizing or reducing nature of the fuel cell environment. Examples of flow plate materials include, for example, silver, copper, ferrous materials, strontium, lanthanum, chromium, chrome, gold, platinum, palladium, nickel, titanium, conducting ceramics (e.g., doped rare earth oxides of chromium, manganese, cobalt, nickel, and the like; doped zirconia, including, zirconia doped with titanium, copper, and the like), and the like, as well as alloys, oxides, cermets, composites, and combinations comprising at least one of the foregoing materials. In short, flow plate design and construction not only affect the efficiency and operational parameters of the individual electrochemical cells, they also become an important consideration in combining cells into a cell stack.

Each individual electrochemical cell 10 generates a relatively small voltage, generally about 0.5 to about 1.2 volts. However, higher voltages are often required to make this power useful. These higher voltages are attained by electrically connecting a plurality of electrochemical cells in series to form a stack. The total number of cells forming a stack can range from 2 to several hundred, depending on power requirements, space and weight restrictions, economics, and the like. As stated above, cells are often connected through their end plates, making end plate design and construction an important factor in electrochemical cell efficiency.

The dimensions of each cell may vary generally depending on the spatial requirements and the desired output. SOFCs may be employed in areas ranging from a microscopic scale, wherein each cell has an area of several micrometers squared, to an industrial power generation scale, such as in a power plant wherein each cell has an area of several meters squared. Particularly useful dimensions for SOFCs employed in automotive applications are about 50 to about 200 square centimeters per cell (cm²/cell), but it will be understood that these dimensions may vary depending on various design considerations.

In operation, the electrochemical cell 10 produces a current flow as illustrated by current flow arrows 60, 60′ in FIG. 2. Oxidant gases, such as oxygen or air, can be introduced to the cathode side of the cell, flowing as illustrated by the oxidant flow arrows 64, 64′, 64″. The oxidant receives the flowing electrons (e⁻), which converts oxygen into oxygen ions (O⁻²) as depicted in the following reaction:

O₂+4e⁻→2O⁻².

Oxygen ions diffuse through the electrolyte 40 to the anode 30. At the anode, the oxygen ions react with a fuel, such as hydrogen, carbon monoxide, methane, other hydrocarbons, or a combination comprising at least one of the foregoing fuels, which is introduced to the electrochemical cell 10 as illustrated by the fuel flow arrows 62, 62′, 62″, The reaction of the fuel and oxygen ions, produces electrons (e⁻), which flow outside of the electrochemical cell 10 to the external circuit 70 and back to the cathode 50. The fuel/oxygen ion reaction is depicted in the following reactions:

| | |
|---|---|
| H₂ + O⁻² → H₂O + 2e⁻ | (when fuel is hydrogen) |
| CO + O⁻² → CO₂ + 2e⁻ | (when fuel is carbon monoxide) |
| CH₄ + 4O⁻² → 2H₂O + CO₂ + 8e⁻ | (when fuel is methane) |

Unreacted fuel and byproducts, such as water, carbon monoxide, and carbon dioxide, exit the electrochemical cell 10 in the fuel stream, as illustrated by fuel stream arrow 66, while excess oxidant exits the electrochemical cell 10, as illustrated by oxidant stream arrow 68.

Basically, the electrolyte 40 conducts the oxygen ions (O⁻²) between the anode 30 and the cathode 50, maintaining an overall electrical charge balance. The cycle of flowing electrons (e⁻) from the anode 30 through the external circuit 70 to the cathode 50 creates electrical energy for harnessing. This electrical energy can be directly utilized by the vehicle to power various electrical parts, including, but not limited to, lights, resistive heaters, blowers, air conditioning compressors, starter motors, traction motors, computer systems, radio/stereo systems, and a multiplicity of sensors and actuators, among others. The electricity produced by the SOFC is direct current, which can be matched to the normal system voltage of the vehicle. This minimizes or avoids the need for devices such as diodes, voltage conversion and other losses, such as resistive losses in the wiring and in/out of the battery, associated with other vehicle systems and hybrid electrical systems. This high efficiency electricity allows electrification of the vehicle, including functions such as air conditioning and others, while allowing reduced weight, improved fuel economy and improved performance advantages compared to other hybrid electric mechanization and internal combustion engine systems.

During start-up, and for cabin heating, the SOFC can be operated at high adiabatic temperatures, e.g. up to about 1,000° C., subject to catalyst limitations, with typical operating temperatures of about 600° C. to about 900° C., and preferably about 650° C. to about 800° C. Consequently, at least one heat exchanger is preferably employed to cool the SOFC effluent and conversely heat the air prior to entering the SOFC, with conventional heat exchangers generally employed.

To facilitate the production of electricity by the SOFC, a direct supply of simple fuel, (e.g., hydrogen, carbon monoxide, and/or methane) is preferred. However, concentrated supplies of these fuels are generally expensive and difficult to supply. Therefore, the fuel utilized can be obtained by processing a more complex fuel source. The actual fuel utilized in the system is typically chosen based upon the application, expense, availability, and environmental issues relating to the fuel. Possible fuels include hydrocarbon fuels, including, but not limited to, liquid fuels, such as gasoline, diesel, ethanol, methanol, kerosene, and others; gaseous fuels, such as natural gas, propane, butane, and others; and “alternative” fuels, such as hydrogen, biofuels, dimethyl ether, and others; synthetic fuels, such as synthetic fuels produced from methane, methanol, coal gasification or natural gas conversion to liquids, and combinations comprising at least one of the foregoing methods, and the like; as well as combinations comprising at least one of the foregoing fuels. The preferred fuel is typically based upon the type of engine employed. Lighter fuels (i.e., those which can be more readily vaporized), and/or fuels readily available to consumers are generally preferred.

The SOFC may be used in conjunction with an engine, for example, to produce tractive power for a vehicle. Within the engine, SOFC effluent, air, and/or fuel are burned to produce energy, while the remainder of unburned fuel and reformed fuel is used as fuel in the SOFC. The engine can be any combustion engine including, but not limited to, internal combustion engines such as spark ignited and compression ignited engines, including, but not limited to, variable compression engines.

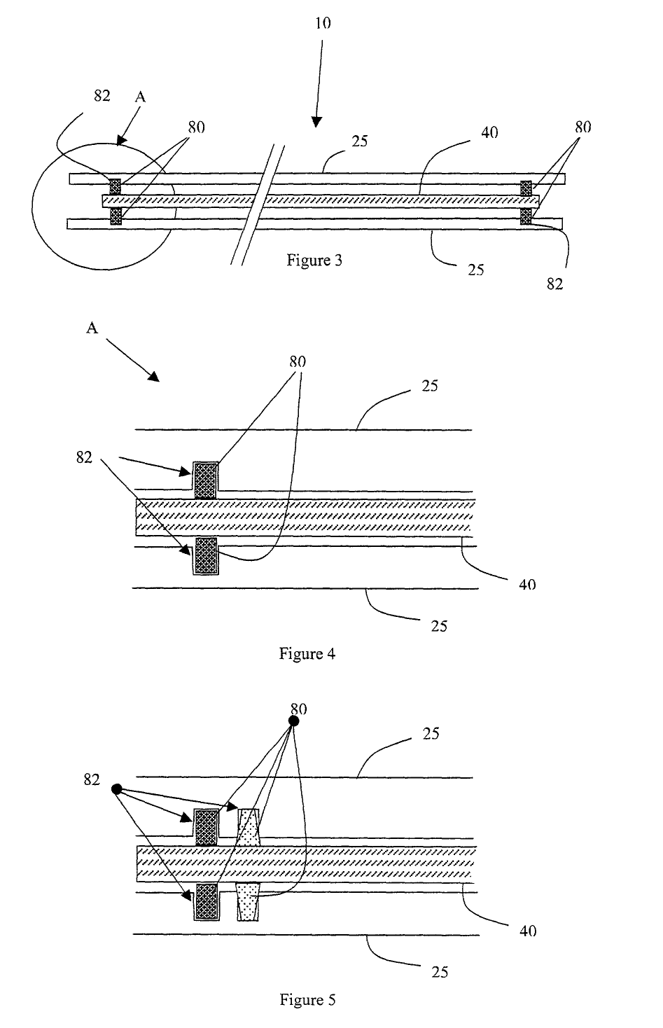

In order for the electrochemical cell 10 to function properly, a pressure tight seal which can be disposed between the flow plate 25 and the remainder of the fuel cell is required to ensure oxidant and fuel flow to the anode and cathode, (as appropriate), and to prevent mixing of the two streams. A seal member 80 (see FIGS. 3 and 4), or a plurality of seal members (see FIG. 5), can be used to provide a pressure tight seal between the flow plate 25, and the electrode disposed on the electrolyte 40 adjacent to it. Seal member 80 is preferably disposed between the flow plate 25, and the adjacent electrode. The seal member 80 can be in the form of a continuous bead of material engaged in a seal retention groove 82, and/or can be in the form of a gasket (e.g., a preformed gasket of the desired shape) that is disposed between the two electrochemical cell parts to be sealed. The seal member 80 may be of any shape, or have any cross-sectional geometry that is consistent with the particular design in which it is being used. Also, to ensure a pressure tight seal, seal member 80 is capable of withstanding the pressures, temperature, and chemical environment within an operating SOFC. The pressures within an operating SOFC can be about 0.01 kPa, to about 10 kPa or more; temperatures can be about −40° C. while not in use, to over 1,000° C. during use; and the chemical environment includes both oxidizing and reductive conditions, depending on the side of the electrode to which the seal is disposed.

It has been discovered that a SOFC seal member comprising a foam is suitable for use as described herein. Suitable foams include those capable of maintaining a pressure tight seal under the temperature, pressure and environmental conditions listed above. These suitable foams include metal foams, metal alloy foams, and combinations comprising at least one of the foregoing foams. For reasons of simplicity, all the above are hereinafter collectively referred to as metal foams.

The properties of a metal foam that render it suitable for use as a seal member 80 within a SOFC include: temperature stability, chemical stability, density, and foam cell type. These properties in-turn depend on the metal foams base materials as well as the method and conditions used to make the metal foam. In the discussion that follows, the required temperature and chemical stability of a metal foam are considered first, followed by properties related to the method by which the foam is made. Finally, various suitable methods of making metal foams are discussed. It should be understood that the terms method, process, making, producing, manufacturing, and the like, are used herein as equivalents to represent the means by which the metal foams are brought into existence. Both the temperature stability and the chemical stability of a metal foam depend in part upon the properties of the base materials. Base materials, as used herein, are defined as the elemental and chemical compositions of the materials from which the metal foam is comprised. As stated above, suitable metal foams provide a pressure tight seal at temperatures of about −40° C. to over 1,000° C., thus, the base materials do not melt in this temperature range, and exhibit a level of expansion and contraction consistent with the SOFC design. Suitable base materials also remain inert, or substantially unaltered in the corrosive (oxidative and/or reductive) environments within an operating SOFC.

Suitable base materials as used herein include metals, compounds containing metals, conducting ceramics, (e.g., doped zirconia, including zirconia dipped with titanium, copper and the like), or combinations comprising at least one of the foregoing. Preferably, the base material comprises silver, copper, ferrous materials, strontium, aluminum, lanthanum, chromium, gold, platinum, palladium, nickel, titanium, and the like, as well as alloys, oxides, hydrides, cermets, composites, salts, and combinations comprising at least one of the foregoing materials. The preferred base material being nickel, silver coated nickel, and combinations comprising at least one of these materials, due to their relatively good corrosion characteristics in hot air. A metal is preferred over a ceramic due to its lower Young's modulus (which when foamed becomes even lower). The lower Young's modulus makes for more compliance and a more effective seal. The specific oxide scale characteristics of the metal are also relevant characteristics of the desired base material.

Other properties of the metal foams are a function of the method from which the metal foam is made, produced, or manufactured. For example, metal foam density depends on the process or method used to produce the metal foam (e.g., the average cell size, wall thickness, and material distribution within the metal foam), and the density of the base material or materials used. Suitable metal foams have densities of greater than or equal to about 0.0089 grams per milliliters (g/ml), preferably greater than or equal to about 0.089 g/ml, with a density of greater than or equal to about 0.45 g/ml being most preferred. Suitable metal foams also have densities less than or equal to about 7.1 g/ml, preferably at less than or equal to about 4.45 g/ml, with a density of less than or equal to about 2.67 g/ml being most preferred. Other method dependent inherent properties of a metal foam include the foam cell-type.

The density of the metal foam can be about 0.1% to about 80%. Within this range, a porosity of greater than or equal to about 1% is preferred, with greater than or equal to about 5% more preferred, based upon the parent material. Also preferred within this range is a porosity of less than or equal to about 50%, with less than or equal to about 20% more preferred.

Another controlled property of the metal foam is the cell type, which refers to the base material distribution and arrangement within the three-dimensional structure of the metal foam. Foam cells may be termed as open-celled, closed-celled, or some combination of both. Open-celled metal foams being defined herein as those that are permeable to fluids, thus open-celled metal foams provide a path through the metal foam. Open-celled metal foams comprise individual cells in fluid communication with adjacent cells. Closed-celled metal foams do not provide fluid communication between cells and thus are not permeable. Closed cell metal foams comprise an aggregation of sealed cells that seal against fluid flow. In addition, metal foams exist that are combinations of both open and closed cell types. The metal foam can be a closed cell foam or a combination of a closed cell foam and an open cell foam that comprises sufficient closed cells to prevent fluid communication through the metal foam.

Suitable metal foam manufacturing methods/processes include: gas-metal eutectic solidification; entrapped gas expansion; melt gas injection (air bubbling); gas releasing particle decomposition in a melt; gas releasing particle decomposition in semi solids; hollow particle aggregation; open-cell mold solidification; cellular pre-form metal deposition and the like, as well as combinations comprising at least one of the foregoing methods. Each of the metal foam manufacturing methods are discussed below in no particular order of presentation:

With the gas-metal eutectic solidification method, numerous metal alloy-hydrogen binary phase mixtures that exhibit a eutectic can be exploited. An alloy is melted, saturated with an inert gas (e.g., hydrogen gas, or the like) and then directionally solidified. During solidification, solid metal and hydrogen simultaneously form from the gas eutectic reaction, resulting in a porous material containing inert gas hydrogen filled pores. For example, an alloy is melted under an appropriate pressure of hydrogen (e.g., about 5 to about 10 atmospheres H₂), and then poured into a mold where directional eutectic solidification occurs.

A second method of metal foam production is the entrapped gas expansion method. This process involves entrapment of an inert gas and a metal or metal alloy (often in the form of a powder) in a sealed container. The container is then consolidated by hot isostatic pressing. A rolling process is then used to break up the pore structure of the consolidated material. The material is then expanded by heating at a sufficient temperature (e.g., about 800° C. to about 1,100° C.), for a sufficient time (e.g., about 20 to about 30 hours) to make the metal foam.

Another method of making a metal foam comprises the melt gas injection method that involves the injection of a gas, or gas forming liquid into a molten metal or metal alloy comprising a viscosity improver. As gas is injected into the molten metal or metal alloy, the gas being less dense floats to the surface to form individual bubbles. The bubbles coalesce to form a metal foam. This metal foam is cooled and allowed to solidify to produce the final metal foam. The viscosity improvers enable the formation of a metal foam that is stable for a sufficient period of time to allow the material to solidify. Viscosity improvers utilized herein include small insoluble particles comprising ceramic materials such as, for example, alumina, zirconia, silicon carbide, titanium dioxide, and the like, as well as combinations comprising at least one of the foregoing ceramic materials. The viscosity improver particles typically have a length of about 0.5 to about 25 micrometers to obtain the desired porosity as set forth above. In this method, air, carbon dioxide, oxygen, inert gases, and liquids such as water, can be injected into the molten metal or metal alloy to create the bubbles.

Yet another method for making a metal foam using gas bubbles is the gas-releasing particle decomposition in a melt method. In this method, a solid material that rapidly decomposes into a metal and a gas is used to form bubbles within an alloy melt, instead of introducing a gas directly as described above. The method involves first dispersing a gas forming material, typically a metal hydride, in a molten metal, or metal alloy. Once the material is dispersed, the gas is released by heating the material to a temperature sufficient to decompose the metal hydride. The bubbles released produce a metal foam above the melt. Once formed, the metal foam is solidified by cooling before the gas escapes, and before the bubbles have the opportunity to coalesce and/or collapse.

The next method discussed is the gas-releasing particle decomposition in a semi-solid method. This method includes combining particles of a foaming agent (typically a metal hydride) with a metal or metal alloy in powdered form. After the ingredients are thoroughly mixed, the powder is cold compacted. The material is then heated to a temperature sufficient to soften the metal or metal allow powder, and decompose the foaming agent, thereby releasing the gas. This gas creates voids in the material, which results in the formation of a metal foam.

Still another method of forming a metal foam suitable for use herein involves first forming a plurality of hollow metal particles, and then incorporating them into a metal foam. Hollow metal particles can be produced by first forming a slurry, comprising metal hydride particles (e.g., titanium hydride (TiH₂), and the like), organic binders and solvents. This slurry is then poured through a sieve in a drop tower to produce liquid spheres, which are hardened by evaporation during flight. These spheres are then heated to remove solvents, binders, and other processing aids originally used in the slurry. A final annealing treatment decomposes the metal hydride to produce hollow metal particles. These hollow metal particles are then incorporated into a foam having a variety of shapes and designs through methods of consolidation including: hot isostatic pressing (HIP-ing), vacuum sintering, liquid phase sintering, a combinations comprising at least on of the foregoing, and the like.

The above methods of metal foam making involve forming a metal foam from the expansion of a gas within a metal, the methods that follow involve using an existing foam as a template from which a metal foam is formed.

Solidification in an open-celled mold is a method of making metal foam that uses a reticulated open-cell “polymer” foam as template. From this template, an investment-casting mold is created into which a suitable metal or alloy is cast. The process involves coating polymer foam with a mold casting (e.g., ceramic powder) slurry, which is then dried and embedded in casting sand. The mold is then baked to both harden the casting material, and decompose (and/or evaporate) the polymer foam template. The result is a negative image of the foam, which is then used as a mold. This mold is subsequently filled with a metal or metal alloy. After the metal or metal alloy is allowed to cool, the mold materials are removed, leaving behind the metal equivalent of the original polymer foam.

Polymeric foam is also used as a template in forming a metal foam by the metal deposition on “cellular pre-forms” method. In this method, polymer foams are used as templates (i.e., pre-forms) upon which metal is deposited by chemical vapor deposition, electro-deposition, or the like. Once the pre-form is coated with a metal or metal alloy, it is then heated, preferably in an oxygen containing environment, to remove the polymer foam core. The result is a cellular metal structure in the shape of the foam pre-core having hollow ligaments. Subsequent sintering of the cellular metal structure is used to densify these ligaments into a metal foam suitable for use herein.

Suitable metal foams can thus be made by any of the afore described methods, or a combination of at least one of the foregoing methods. Preferably, seal member 80 comprises a metal foam made from the hollow sphere consolidation method with subsequent surface treatment for uniform surface finish. This method is preferred because it results in a gas impervious structure with smooth surfaces suitable for a seal.

### EXAMPLES

Hollow sphere consolidation of Ni spheres via hot isostatic pressing can be used to create a sheet of metal foam 150 micrometers thick. This sheet is then die cut to include the desired seal shape and features. The resultant seal is silver coated for oxidation resistance. Since this application is a non-electrically conducting seal, the resulting metal seal would be assembled between two sheets of similarly die cut mica or similar dielectric material that provides electrical insulation. Depending on the resulting surface finish of the metal foam, and the Young's modulus of the mica used, a “void filling” step such as a plasma spray of Ni material may then be employed.

As the examples demonstrate, the use of metal foam as described herein provides for an improvement of seal member temperature stability and chemical stability over the elastomeric seals. In particular, the use of a metal foams allow for a seal capable of withstanding the operational pressures and temperatures of a SOFC for a period exceeding about 10,000 hours, while an elastomeric seal generally decomposes after about 0.1 hours; and a seal member compatible with the oxidizing and/or reducing nature of the fuel cell environment. Thus, the seal member described herein allows for the successful operation of a fuel cell through maintaining structural stability of fuel cell components during steady state conditions, as well as transient operational conditions. Use of the seal member described herein thus reduces or eliminates leaks in manifolds, and other defects that can lead to SOFC failure.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A solid oxide fuel cell, comprising:
an electrolyte disposed between and in ionic communication with a first electrode and a second electrode, forming an electrochemical cell;
a flow plate disposed adjacent to and in electrical communication with at least a portion of the electrochemical cell; and
a seal member sealably engaging the flow plate, wherein the seal member comprises a foam selected from the group consisting of a metal, a metal alloy, and combinations comprising at least one of the foregoing foams.

2. The solid oxide fuel cell of claim 1, wherein the flow plate is an end cap.

3. The solid oxide fuel cell of claim 1, wherein the flow plate is an interconnect.

4. The solid oxide fuel cell of claim 1, wherein the metal is selected from the group consisting of silver, copper, ferrous materials, strontium, aluminum, lanthanum, chromium, gold, platinum, palladium, nickel, titanium, and alloys, oxides, hydrides, cermets, composites, salts, and combinations comprising at least one of the foregoing metals.

5. The solid oxide fuel cell of claim 1, wherein the metal comprises nickel.

6. The solid oxide fuel cell of claim 5, wherein the metal comprises silver coated nickel.

7. The solid oxide fuel cell of claim 1, wherein the foam has a density of about 0.0089 g/ml and about 7.1 g/ml.

8. The solid oxide fuel cell of claim 7, wherein the density is about 0.089 g/ml to about 4.45.

9. The solid oxide fuel cell of claim 8, wherein the density is about 0.45 g/ml to about 2.67 g/ml.

10. The solid oxide fuel cell of claim 1, wherein the foam has a density of about 0.1% to about 80%.

11. The solid oxide fuel cell of claim 10, wherein the density is about 1% to about 50%.

12. The solid oxide fuel cell of claim 1, wherein the density is about 5% to about 20%.

13. The solid oxide fuel cell of claim 1, further comprising a dielectric insulator disposed between the seal member and the flow plate.

14. The solid oxide fuel cell of claim 1, further comprising a dielectric insulator disposed between the seal member and the electrochemical cell.

15. The solid oxide fuel cell of claim 1, wherein the seal member is in the form of a gasket.

16. The solid oxide fuel cell of claim 1, wherein the seal member is in the form of a continuous bead.

17. A method of manufacturing a solid oxide fuel cell, comprising:
disposing a first electrode and a second electrode on opposite sides of a solid electrolyte;
disposing a flow plate adjacent to and in electrical communication with at least a portion of the electrochemical cell; and
disposing a seal member in sealable engagement with the flow plate, wherein the seal member comprises a foam selected from the group consisting of a metal, a metal alloy, and combinations comprising at least one of the foregoing foams.

18. The method of claim 17, wherein the metal is selected from the group consisting of silver, copper, ferrous materials, strontium, aluminum, lanthanum, chromium, gold, platinum, palladium, nickel, titanium, and alloys, oxides, hydrides, cermets, composites, salts, and combinations comprising at least one of the foregoing metals.

19. The method of claim 17, wherein the metal comprises nickel.

20. The method of claim 19, wherein the metal comprises silver coated nickel.

21. The method of claim 17, wherein the foam has a density of about 0.0089 g/ml and about 7.1 g/ml.

22. The method of claim 21, wherein the density is about 0.089 g/ml to about 4.45.

23. The method claim 22, wherein the density is about 0.45 g/ml to about 2.67 g/ml.

24. The method of claim 17, wherein the foam has a density of about 0.1% to about 80%.

25. The method of claim 24, wherein the density is about 1% to about 50%.

26. The method of claim 25, wherein the density is about 5% to about 20%.

27. The method of claim 17, further comprising disposing a first dielectric insulator between the seal member and the electrochemical cell and disposing a second dielectric insulator between the seal member and the flow plate.

28. The method of claim 17, wherein the seal member is in the form of a gasket.
